(19) United States
(12) Patent Application Publication
(10) Pub. No.: US 2008/0094334 A1
(43) Pub. Date: Apr. 24, 2008

(54) DATA DRIVING APPARATUS, LIQUID CRYSTAL DISPLAY INCLUDING THE SAME, AND METHOD OF DRIVING LIQUID CRYSTAL DISPLAY

(75) Inventors: Seung-ho BAEK, Cheonan-si (KR); Min-sung CHOI, Cheonan-si (KR); Hyoung-wook KIM, Busan (KR); Sang-youn KIM, Daegu (KR); Byoung-haw PARK, Cheonan-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 11/876,844

(22) Filed: Oct. 23, 2007

(30) Foreign Application Priority Data
Oct. 23, 2006 (KR) 10-2006-0103039

(51) Int. Cl. G09G 3/36

(52) U.S. Cl. 345/89

(57) ABSTRACT

A data driving apparatus includes; an integrated circuit chip, a grayscale voltage generation unit disposed on the integrated circuit chip which receives grayscale generation signals from the outside and generates a plurality of reference grayscale voltages, and a driving unit disposed on the integrated circuit chip which receives the reference grayscale voltages, converts image signals from the outside into corresponding analog data voltages, and supplies the converted analog data voltages to data lines of a liquid crystal panel.

This application claims priority to Korean Patent Application No. 10-2006-0103039, filed on Oct. 23, 2006, and all the benefits accruing therefrom under 35 U.S.C. §119, the contents of which in its entirety are herein incorporated by reference.

### BACKGROUND OF THE INVENTION

1. Field of the Invention

The present invention relates to a data driving apparatus, a liquid crystal display including the same, and a method of driving a liquid crystal display. In particular, the present invention relates to a data driving apparatus which reduces manufacturing costs and improves display quality, a liquid crystal display including the same, and a method of driving the liquid crystal display.

2. Description of the Related Art

Generally, a liquid crystal display which displays an image using a liquid crystal is one kind of a flat panel display device. The liquid crystal display is thin and lightweight and has low power consumption and low driving voltage compared with other display devices.

The liquid crystal display (hereinafter, referred to as “LCD”) includes a color filter display substrate on which a reference electrode and color filters are formed, a thin film substrate on which thin film transistors and pixel electrodes are formed, and a liquid crystal layer interposed between the two substrates. An electric field is generated by applying different electric potentials, also called voltages, to the pixel electrodes and the reference electrode, the alignment of liquid crystal molecules change with the generated electric field. Transmittance of light passing through the liquid crystal layer is controlled by the alignment of the liquid crystal molecules. The LCD then manipulates the transmittance of a plurality of pixels to thereby display an image.

According to the related art, a printed circuit board (“PCB”), on which a plurality of electronic components for driving a liquid crystal panel and for generating control signals are mounted, is electrically connected to a data driving unit on one side of a liquid crystal panel. The PCB is provided with a grayscale voltage generation unit which generates a plurality of reference grayscale voltages and a plurality of wiring lines which transmit the plurality of reference grayscale voltages generated by the grayscale voltage generation unit to the data driving unit. Accordingly, the PCB includes a large number of the wiring lines formed thereon. Further, since the reference grayscale voltages to be transmitted to the data driving unit through the plurality of wiring lines are analog voltages, the reference grayscale voltages may be distorted due to noise generated by the analog voltages passing through the other wiring lines.

Further, the reference grayscale voltages are not adjusted according to image signals supplied from the outside but are arbitrarily generated and supplied to the data driving unit. Therefore, it is difficult to represent fine image quality from a black grayscale level to a white grayscale level when the reference grayscale voltages have an arbitrarily supplied voltage.

### BRIEF SUMMARY OF THE INVENTION

An aspect of the present invention is to provide a data driving apparatus which can reduce manufacturing costs and improve display quality.

Another aspect of the present invention is to provide a liquid crystal display including a data driving apparatus which can reduce manufacturing costs and improve display quality.

Still another aspect of the present invention is to provide a method of driving a liquid crystal display which can reduce manufacturing costs and improve display quality.

Aspects of the present invention are not limited to those mentioned above, and other aspects of the present invention will be understood by those skilled in the art through the following description.

According to an exemplary embodiment of the present invention, there is provided a data driving apparatus including; an integrated circuit chip, a grayscale voltage generation unit disposed on the integrated circuit chip which receives grayscale generation signals from the outside and generates a plurality of reference grayscale voltages, and a driving unit disposed on the integrated circuit chip which receives the reference grayscale voltages, converts the image signals supplied from the outside into corresponding analog data voltages, and supplies the converted analog data voltages to data lines of a liquid crystal panel.

According to another exemplary embodiment of the present invention, there is provided a liquid crystal display including; a liquid crystal panel including a plurality of unit pixels provided substantially at intersections of a plurality of gate lines and a plurality of data lines, a timing control unit which generates control signals which drive the liquid crystal panel, and receive image signals for every frame, wherein the timing control unit includes an image signal correction unit which determines to which grayscale level the distribution of the image signal received in an n-th frame corresponds among a plurality of grayscale levels and outputs a corrected image signal according to the result of the determination, a driving voltage generation unit which receives the control signals and generates a plurality of driving voltages, a gate driving unit which receives the driving voltages and applies the received driving voltages to the gate lines, and a data driving apparatus including an integrated circuit chip, a grayscale voltage generation unit dispose on the integrated circuit chip which receives grayscale generation signals from the outside and generates a plurality of reference grayscale voltages, and a driving unit dispose on the integrated circuit chip which receives the reference grayscale voltages, converts the corrected image signals from the timing control unit into corresponding analog data voltages, and supplies the converted analog data voltages to the data lines of the liquid crystal panel.

According to still another exemplary embodiment of the present invention, there is provided a method of driving a liquid crystal display, the method including; providing a liquid crystal display which includes switching elements correspondingly connected to a plurality of gate lines and data lines and a plurality of pixels arranged at intersections of the plurality of gate lines and data lines in a matrix shape, applying driving voltages to the gate lines, receiving image signals for every frame, determining which grayscale level the distribution of the image signals received in an n-th frame corresponds to among a plurality of grayscale levels, supplying a corrected image signal according to the result of the determination to a data driving unit, transmitting grayscale generation signals from a timing control unit to the data driving unit, generating a plurality of reference grayscale voltages in the data driving unit, converting the corrected image signals into corresponding analog data voltages, and supplying the converted analog data voltages to the data lines.

### BRIEF DESCRIPTION OF THE DRAWINGS

The above and other aspects, features and advantages of the present invention will become more apparent by describing in further detail exemplary embodiments thereof with reference to the attached drawings, in which:

FIG. 1 is a block diagram of an exemplary embodiment of a liquid crystal display according to the present invention;

FIG. 2 is a diagram showing offset voltage values according to an exemplary embodiment of the present invention;

FIG. 3 is an internal block diagram of an exemplary embodiment of an image signal correction unit according to the present invention;

FIG. 4 is an internal block diagram of an exemplary embodiment of a color correction unit shown in FIG. 3;

FIG. 5 is an internal block diagram of an exemplary embodiment of a grayscale signal correction unit shown in FIG. 3;

FIG. 6 is a diagram showing an exemplary embodiment of a method of applying a data voltage according to the present invention;

FIG. 7 is an internal block diagram of an exemplary embodiment of a data driving unit according to the present invention;

FIG. 8 is an internal block diagram of an exemplary embodiment of a grayscale voltage generation unit shown in FIG. 7;

FIG. 9 is an internal block diagram of an exemplary embodiment of a resistor string unit shown in FIG. 8; and

FIG. 10 is an internal block diagram of an exemplary embodiment of a driving unit shown in FIG. 7.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, embodiments according to the present invention will be described in further detail with reference to the accompanying drawings.

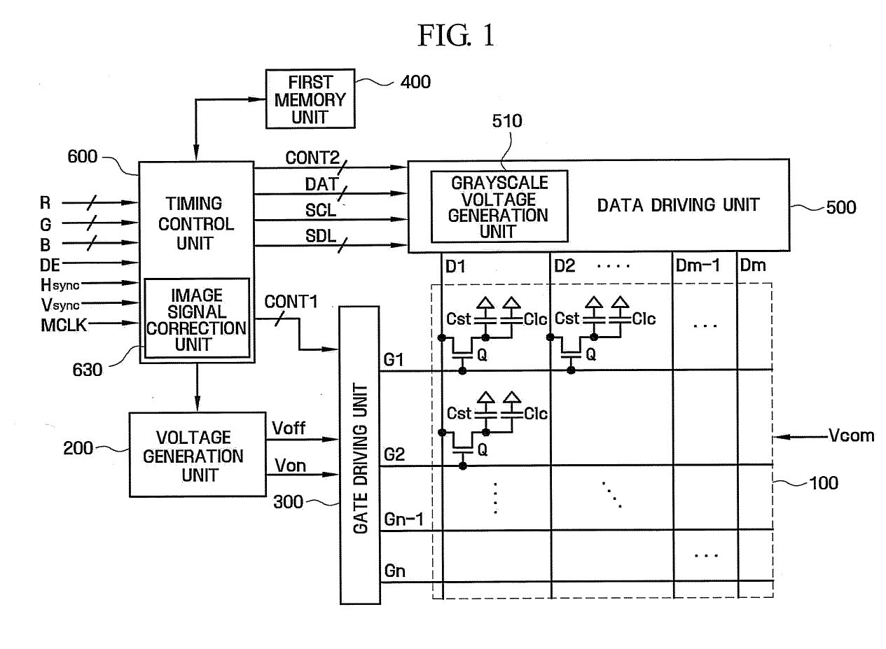

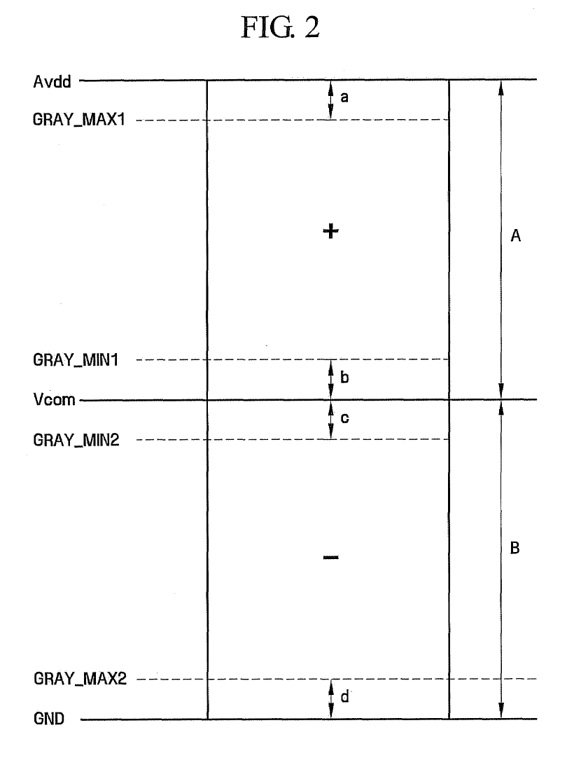

FIG. 1 is a block diagram of an exemplary embodiment of a liquid crystal display according to the present invention. FIG. 2 is a diagram showing offset voltage values according to an exemplary embodiment of the present invention.

As shown in FIG. 1, the exemplary embodiment of a liquid crystal display according to present invention includes a liquid crystal panel 100, a voltage generation unit 200, a gate driving unit 300, a first memory unit 400, a data driving unit 500, and a timing control unit 600.

Referring to an FIG. 1, the liquid crystal panel 100 includes a plurality of display signal lines G1 to Gn and D1 to Dm. The liquid crystal panel 100 also includes a plurality of unit pixels which are correspondingly connected to the display signal lines G1 to Gn and D1 and Dm and arranged in a matrix shape. The liquid crystal panel 100 includes a color filter display substrate on which a reference electrode and color filters are formed, a thin film substrate on which thin film transistors (“TFTs”) and pixel electrodes are formed, and a liquid crystal layer interposed between the two substrates.

Here, the display signal lines G1 to Gn and D1 to Dm includes a plurality of gate lines G1 to Gn which transmit gate signals and a plurality of data lines D1 to Dm which transmits data signals. The gate lines G1 to Gn extend substantially in a row direction so as to be substantially parallel to one another, and the data lines D1 to Dm extend substantially in a column direction so as to be substantially parallel to one another.

Each of the unit pixels includes a switching element Q connected to corresponding ones of the display signal lines G1 to Gn and D1 to Dm, a liquid crystal capacitor Clc connected to the switching element Q, and a storage capacitor Cst which is also connected to the switching element Q. Alternative exemplary embodiments include configurations wherein the storage capacitor Cst is omitted.

The switching element Q is a three-terminal element, exemplary embodiments of which include a TFT. A control terminal of the switching element Q is connected to a corresponding one of the gate lines G1 to Gn, an input terminal thereof is connected to a corresponding one of the data lines D1 to Dm, and an output terminal thereof is connected to the liquid crystal capacitor Clc and the storage capacitor Cst.

The liquid crystal capacitor Clc includes a pixel electrode of the TFT substrate and a common electrode of the color filter substrate as two terminals thereof, and also has a liquid crystal layer disposed between the two electrodes which functions as a dielectric. The pixel electrode is connected to the switching element Q, and the common electrode is formed on substantially the entire surface of the color filter substrate and is supplied with a common voltage Vcom. Alternative exemplary embodiments include configurations wherein the common electrode may be provided on the TFT substrate. In such an alternative exemplary embodiment the two electrodes may be formed in a linear or a bar shape.

In the exemplary embodiment wherein the storage capacitor Cst is included, the liquid crystal panel also includes an additional signal line (not shown) provided on the TFT substrate which overlaps the pixel electrode. In one exemplary embodiment a predetermined voltage, such as the common voltage Vcom, is applied to the additional signal line in what is referred to as an independent wiring method. In an alternative exemplary embodiment, the storage capacitor Cst may be a laminated structure including the pixel electrode, the insulator, and a previous gate line formed on the TFT substrate in what is referred to as a previous gate method.

Meanwhile, in order to display colors, each unit pixel may display a color. Color display may be performed by providing color filters, exemplary embodiments of which include red, green, and blue, in regions corresponding to the pixel electrodes. Here, the color filters may be provided in the regions of the color filter substrate which correspond to the underlying pixel electrodes. Exemplary embodiments include configurations wherein the color filters may be provided above or below the pixel electrodes of the TFT substrate.

A polarizer (not shown) for polarizing light is attached to an outer surface of at least one of the TFT substrate and the color filter substrate of the liquid crystal panel 100.

The voltage generation unit 200 generates a plurality of driving voltages. For example, the voltage generation unit 200 generates a gate-on voltage Von, a gate-off voltage Voff, and the common voltage Vcom.

The gate driving unit 300 is connected to the gate lines G1 to Gn of the liquid crystal panel 100 and supplies gate selection signals, which are combinations of the gate-on voltage Von and the gate-off voltage Voff, to the gate lines G1 to Gn.

The first memory unit 400 is provided outside the data driving unit 500 and stores grayscale generation signals GMA_GEN for generating reference grayscale voltages. At this time, the first memory 400 stores the gray scale generation signals GMA_GEN which correspond to a plurality of grayscale levels, an automatic color calibration (“ACC”) look-up table for correcting colors, and a dynamic capacitance compensation (“DCC”) look-up table for improving a response speed of liquid crystal. The first memory may be an electrically erasable programmable read only memory (“EEPROM”).

Here, the grayscale generation signals GMA_GEN have a plurality of voltage values and offset voltage values. As shown in FIG. 2, a first voltage region A indicates a set of voltage values between the common voltage Vcom and a driving voltage Avdd and a second voltage region B indicates a set of voltage values between the common voltage Vcom and a ground voltage GND. The offset voltage values includes a first offset voltage value (a) which indicates a voltage difference between the driving voltage Avdd and a positive maximum grayscale voltage GRAY_MAX1 in the first voltage region A, a second offset voltage value (b) which indicates a voltage difference between the common voltage Vcom and a positive minimum grayscale voltage GRAY_MIN1 in the first voltage region A, a third offset voltage value (c) which indicates a voltage difference between the common voltage Vcom and a negative minimum grayscale voltage GRAY_MIN2 in the second voltage region B, and a fourth offset voltage value (d) which indicates a voltage difference between the ground voltage GND and a negative maximum grayscale voltage GRAY_MAX2 in the second voltage region B.

The different voltage regions A and B correspond to different voltage polarities with respect to the ground voltage GND. In order to display moving images the LCD rapidly displays a series of images which the eye then interprets as motion. Each image in the series of images is displayed for a short period of time, e.g., one thirtieth of a second, which is also called a frame. If images data signals of only one polarity are sent to the liquid crystal panel 100, the liquid crystal molecules are twisted in only one direction and will rapidly degrade. However, if data signals of alternating polarity are applied to the liquid crystal panel the liquid crystal molecules are twisted in opposing directions depending on the polarity of the data signal and their rapid degradation can be reduced or effectively prevented.

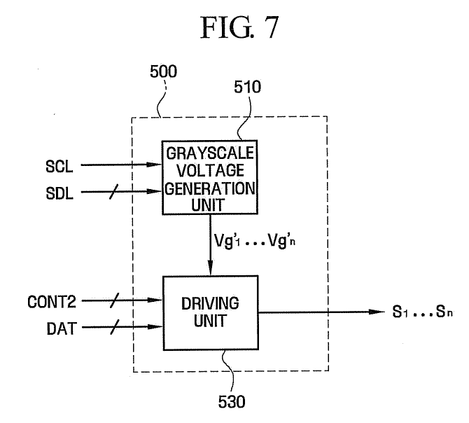

The data driving unit 500 is connected to the data lines D1 to Dm of the liquid crystal panel 100, generates a plurality of data voltages based on the plurality of grayscale voltages generated from a grayscale voltage generation unit 510, selects a grayscale voltage, and supplies the selected grayscale voltage to the unit pixel as the data signal. In one exemplary embodiment the data driving unit 500 may be an integrated circuit (“IC”) chip. The grayscale voltage generation unit 510 will be described in further detail later with reference to FIGS. 7 to 9.

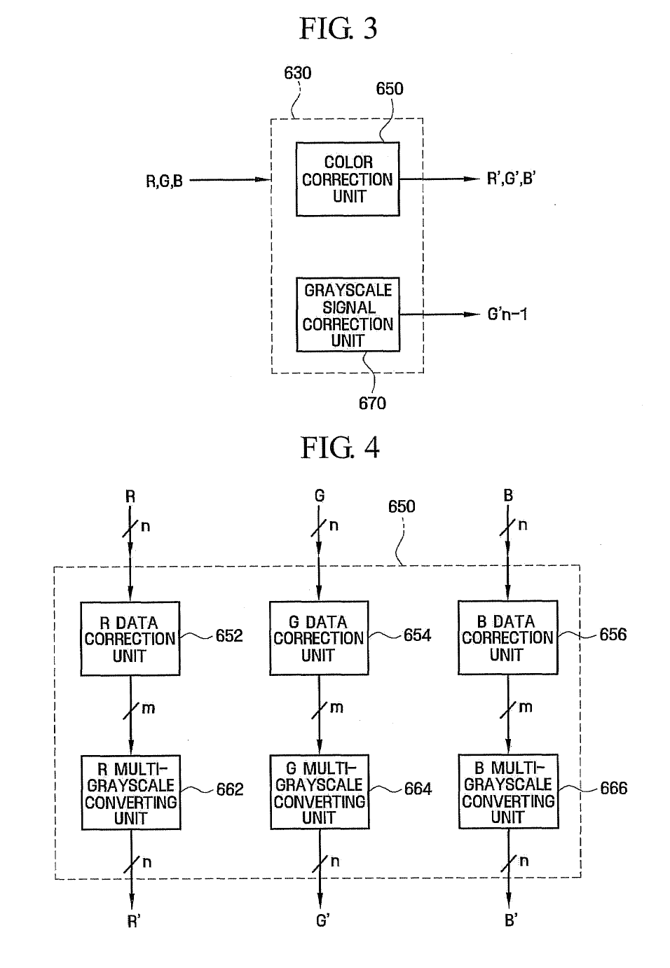

The timing control unit 600 generates control signals which control the operation of the gate driving unit 300 and the data driving unit 500. The timing control unit 600 then supplies the generated control signals to the gate driving unit 300 and the data driving unit 500. In the current exemplary embodiment, the timing control unit 600 includes an image signal correction unit 630 which corrects and outputs an image signal received in an n-th frame. The image signal correction unit 630 will be described below in further detail with reference to FIGS. 3, 5, and 6.

Hereinafter, the operation of the above-described liquid crystal display will be described in further detail.

The timing control unit 600 receives image signals R, G, and B and the input control signals for controlling display of the image signals from an external graphic controller (not shown). For example, the timing control unit 600 receives a vertical synchronization signal Vsync, a horizontal synchronization signal Hsync, a main clock MCLK, and a data enable signal DE. The timing control unit 600 generates a gate control signal CONT1 and a data control signal CONT2 on the basis of the input control signals and processes the image signals R, G, and B to conform to the operational conditions of the liquid crystal panel 100. After the image signals R, G, and B are processed they become modified image signals R′, G′ and B′.

Here, the gate control signal CONT1 includes a vertical synchronization start signal STV indicating the start of outputting a gate-on pulse (gate-on voltage period), a gate clock signal CPV for controlling the output timing of the gate-on pulse, and an output enable signal OE for defining the width of the gate-on pulse. The output enable signal OE and the gate clock signal CPV are supplied to the voltage generation unit 200.

The data control signal CONT2 includes a horizontal synchronization start signal STH indicating the start of inputting the modified image signals R′, G′ and B′, a load signal TP for allowing data voltages to be supplied to the data lines D1 to Dm, a polarity signal POL for inverting the polarity of a data signal voltage (hereinafter, “the polarity of the data voltage with respect to the common voltage” is simply referred to as “the polarity of the data voltage”), and a data clock signal HCLK.

Specifically, the timing control unit 600 according to the current exemplary embodiment of the present invention reads at least one of the grayscale generation signal GMA_GEN stored in the first memory 400, the ACC look-up table for correcting the colors, and the DCC look-up table for improving the response speed of liquid crystal.

Thereafter, the timing control unit 600 receives the image signals R, G, and B and determines a grayscale level to which the distribution of the image signal received in the n-th frame corresponds among a plurality of grayscale levels. Here, the plurality of grayscale levels include a first grayscale level, a second grayscale level, and a third grayscale level. The first grayscale level corresponds to a low grayscale level and indicates an applied grayscale voltage of less than 50, the second grayscale level corresponds to a medium grayscale level and indicates an applied grayscale voltage ranging from 50 to 128, and the third grayscale level corresponds to a high grayscale level and indicates an applied grayscale voltage of more than 128. The grayscale voltage generation unit 510 applies grayscales voltages on a binary basis with the lowest, and therefore darkest, grayscale being 0 and the grayscale continuing to brighten as the grayscale increases.

The image signals R, G, and B are corrected and output according to the determination of the grayscale level. For example, if the distribution of the image signals R, G, and B received in the n-th frame corresponds to a first grayscale level among the plurality of grayscale levels, the timing control unit selects the grayscale generation signal GMA_GEN corresponding to the first grayscale level. The timing control unit 600 also selects a value from at least one of the ACC look-up table and the DCC look-up table corresponding to the first grayscale level so as to correct the image signals. The timing control unit 600 then corrects the image signals accordingly to produce modified image signals R′, G′ and B′

As described above, the timing control unit 600 can select the ACC correction for correcting the colors and the DCC correction for improving the response speed of liquid crystal. After the correction of the image signals is completed, the timing control unit 600 supplies the gate control signal CONT1 to the gate driving unit 300, and also supplies the data control signal CONT2, the corrected image signal DAT, and the grayscale generation signal GMA_GEN to the data driving unit 500.

In the current exemplary embodiment of the present invention the corrected image signal DAT is transmitted to the data driving unit 500 using a reduced swing differential signal (“RSDS”) transmission method and the grayscale generation signal GMA_GEN is transmitted to the data driving unit 500 using an inter integrated circuit (“I²C”) transmission method. As shown in FIG. 1, in the I²C transmission method, two signal lines, that is, a serial clock line SCL and a serial data line SDL are used. The timing control unit 600 designates a 7-bit address and a 10-bit address for individual devices for allowing independent access to the devices. The serial clock line SCL is a signal line used to transfer a synchronization clock for transmitting data, which is provided from a master, e.g., the timing control unit 600. Therefore, the serial clock line SCL is a one-way signal line from the timing control unit 600 to the data driving unit 500. The serial data line SDL is a signal line for representing bit information of data to be transmitted. The serial data line SDL is used when the data is transmitted from the timing control unit 600 to the data driving unit 500 or from the data driving unit 500 to the timing control unit 600. Therefore, the serial data line SDL is a two-way signal line.

The data driving unit 500 sequentially receives the corrected image signals DAT corresponding to the unit pixels of one row according to the data control signal CONT2 from the timing control unit 600. Then, the data driving unit 500 selects a data voltage corresponding to each of the corrected image signals DAT and converts the corrected image signal DAT into the corresponding data voltage.

The gate driving unit 300 sequentially supplies the gate-on voltage Von to the gate lines G1 to Gn according to the gate control signal CONT1 from the timing control unit 600 and thereby sequentially turns on the switching elements Q connected to the gate lines G1 to Gn.

During a period when the gate-on voltage Von is supplied to one of the gate lines G1 to Gn and the switching element Q connected to the corresponding one of the gate lines G1 to Gn is turned on [this period is referred to as “1H” or “one horizontal period” and is equal to one cycle of the horizontal synchronization signal Hsync and the data enable signal DE, and the gate clock CPV]. The data driving unit 500 supplies each of the data voltages to the corresponding one of the data lines D1 to Dm. The data voltages supplied to the data lines D1 to Dm are supplied to the corresponding unit pixels through the turned-on switching elements Q.

The alignment of liquid crystal molecules changes depending on a change in electric field generated by the pixel electrode and the common electrode, which causes a change in polarization of light passing through the liquid crystal layer. The change in polarization causes a change in transmittance of light by the polarizers attached to the TFT substrate and the color filter substrate.

In such a manner, the gate-on voltage Von is sequentially supplied to all of the gate lines G1 to Gn for one frame, such that the data voltages are applied to all of the unit pixels. In one exemplary embodiment, when one frame ends, the next frame starts. When the next frame starts the state of the polarity signal POL to be applied to the data driving unit 500 is controlled such that the polarity of the data voltage applied to each unit pixel is inverse to the polarity of the data voltage in the previous frame; this type of polarity inversion is called “frame inversion”. In another exemplary embodiment the polarity of the data voltage applied to one data line may be inverted with respect to adjacent data lines in the same frame according to the characteristic of the polarity signal POL; this type of polarity inversion is called “line inversion”. Further, the polarities of the data voltages to be applied to a row of pixels may be different from one another “dot inversion”.

FIG. 3 is an internal block diagram of the exemplary embodiment of the image signal correction unit 630 according to the present invention. FIG. 4 is an internal block diagram of an exemplary embodiment of the color correction unit 650 shown in FIG. 3.

Referring to FIG. 3, the current exemplary embodiment of an image signal correction unit 630 according the present invention includes a color correction unit 650 and a grayscale signal correction unit 670.

Referring to FIG. 4, the color correction unit 650 includes an R data correction unit 652, a G data correction unit 654, and a B data correction unit 656, and multi-grayscale converting units 662, 664, and 666 for R, G, and B, respectively.

The R, G, and B data correction units 652, 654, and 656 convert n-bit image signals R, G, and B from the outside into predetermined m-bit image signals according to the ACC look-up table stored in the first memory 400 and output the converted m-bit image signals to the multi-grayscale converting units 662, 664, and 666 for R, G, and B, respectively.

The multi-grayscale converting units 662, 664, and 666 for R, G, and B convert the m-bit image signals (wherein m>n) into n-bit image signals for R, G, and B and supplies the converted n-bit image signals to the timing control unit 600. Here, the multi-grayscale converting units 662, 664, and 666 for R, G, and B perform a dithering processing and a frame rate control processing. In one exemplary embodiment the multi-grayscale converting units 662, 664, and 666 for R, G, and B may be one multi-grayscale converting unit.

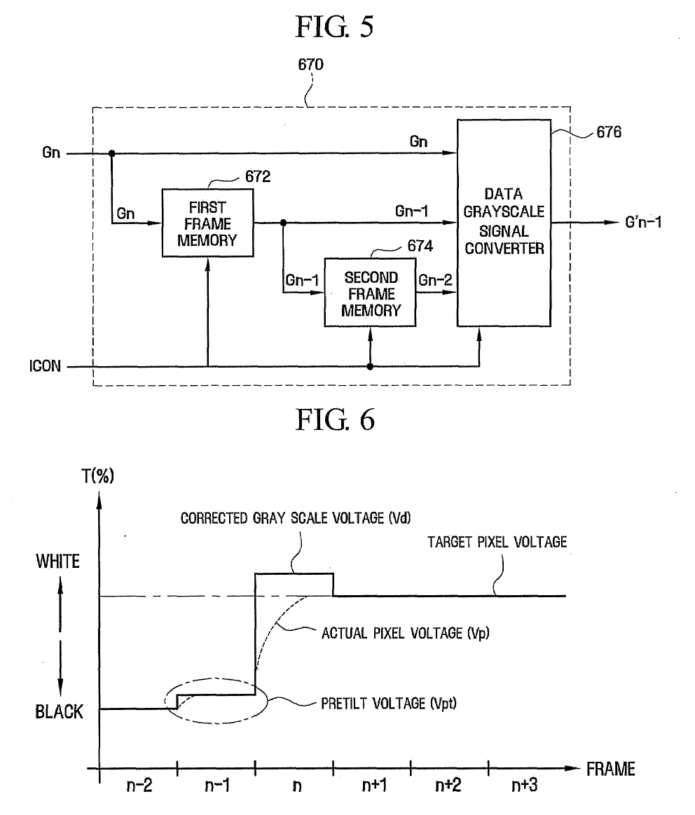

FIG. 5 is an internal block diagram of the exemplary embodiment of a grayscale signal correction unit shown in FIG. 3. FIG. 6 is a diagram showing an exemplary embodiment of a method of applying a data voltage according to the present invention.

Referring to FIG. 5, the grayscale signal correction unit 670 includes a first frame memory 672, a second frame memory 674, and a data grayscale signal converter 676.

The first frame memory 672 outputs an (n−1)-th frame image signal Gn−1 stored from the previous frame to the data grayscale signal converter 676 and the second frame memory 674 in response to a control signal ICON from the timing control unit 600. Further, the first frame memory 672 stores the n-th frame image signal Gn from the timing control unit 600 in response to the control signal ICON. This n-th frame image signal Gn will then be output as the (n−1)-th frame image signal for the next frame.

The second frame memory 674 outputs an (n−2)-th frame image signal Gn−2 stored from the two frames ago to the data grayscale signal converter 676 in response to a control signal ICON from the timing control unit 600. Further, the second frame memory 674 stores the (n−1)-th frame image signal Gn−1 from the first frame memory 674 in response to the control signal ICON. This (n−1)-th frame image signal Gn−1 will then be output as the (n−2)-th frame image signal for the next frame.

The data grayscale signal converter 676 receives the n-th frame image signal Gn, the (n−1)-th frame image signal Gn−1 output from the first frame memory 672, and a (n−2)-th frame image signal Gn−2 output from the second frame memory 674 in response to the control signal ICON from the timing control unit 600. Further, the data grayscale signal converter 676 compares the n-th frame image signal Gn, the (n−1)-th frame image signal Gn−1, and the (n−2)-th frame image signal Gn−2, and outputs an image signal G′n−1 corrected to follow the DCC look-up table. When the n-th frame image signal Gn is input, the (n−1)-th frame image signal Gn−1 is corrected and output. Therefore, the output frame image signal is delayed by one frame.

The data grayscale signal converter 676 outputs the (n−1)-th frame image signal Gn−1 without correction when the n-th frame image signal Gn, the (n−1)-th frame image signal Gn−1, and the (n−2)-th frame image signal Gn−2 are the same. However, when the image signals differ, as when the (n−1)-th frame image signal Gn−1 and the (n−2)-th frame image signal Gn−2 correspond to a black grayscale level and the n-th frame image signal Gn corresponds to a white grayscale level, the (n−1)-th frame image signal Gn−1 is corrected and output as a slightly higher pretilt voltage Vpt such that liquid crystal can be preliminarily pretilted as shown in FIG. 6. Further, in the n-th frame, a grayscale voltage Vd, which is higher than an actual grayscale voltage Vp, is applied, such that the n-th frame more rapidly reaches the white grayscale level. For example, when the black grayscale voltage is in a range of 0.5 to 1.5 V, the pretilt voltage Vpt may be in a range of 2 to 3.5 V. This pretilting of the LCD molecules allows the liquid crystal display to more rapidly switch between light and dark displays and helps to compensate for the relatively slow response time of the liquid crystal molecules.

Further, when the (n−2)-th frame image signal Gn−2 corresponds to the black grayscale level and the (n−1)-th frame image signal Gn−1 and the n-th frame image signal Gn correspond to the white grayscale level, the (n−1)-th frame image signal Gn−1 is corrected and output as an overshoot voltage higher than the white grayscale level.

Alternatively, when the (n−2)-th frame image signal Gn−2 and the (n−1)-th frame image signal Gn−1 correspond to the white grayscale level and the n-th frame image signal Gn corresponds to the black grayscale level, the (n−1)-th frame image signal Gn−1 is corrected and output as a slightly lower pretilt voltage such that liquid crystal can be preliminarily pretilted.

In addition, when the (n−2)-th frame image signal Gn−2 corresponds to the white grayscale level, and the (n−1)-th frame image signal Gn−1 and the n-th frame image signal Gn correspond to the black grayscale level, the (n−1)-th frame image signal Gn−1 is corrected and output as an undershoot voltage which is lower than the black grayscale level. Here, the size of the overshoot or undershoot voltage may be determined by various methods.

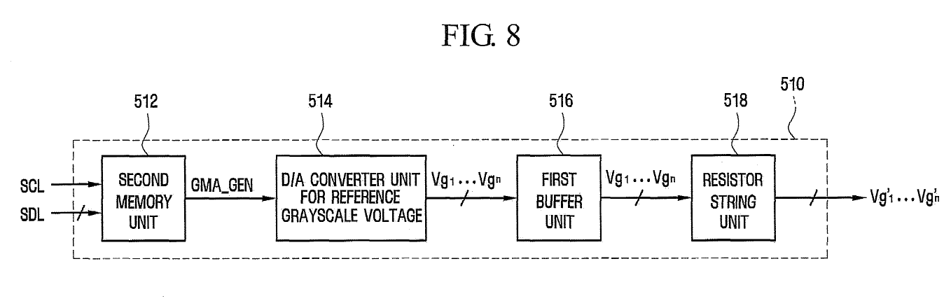

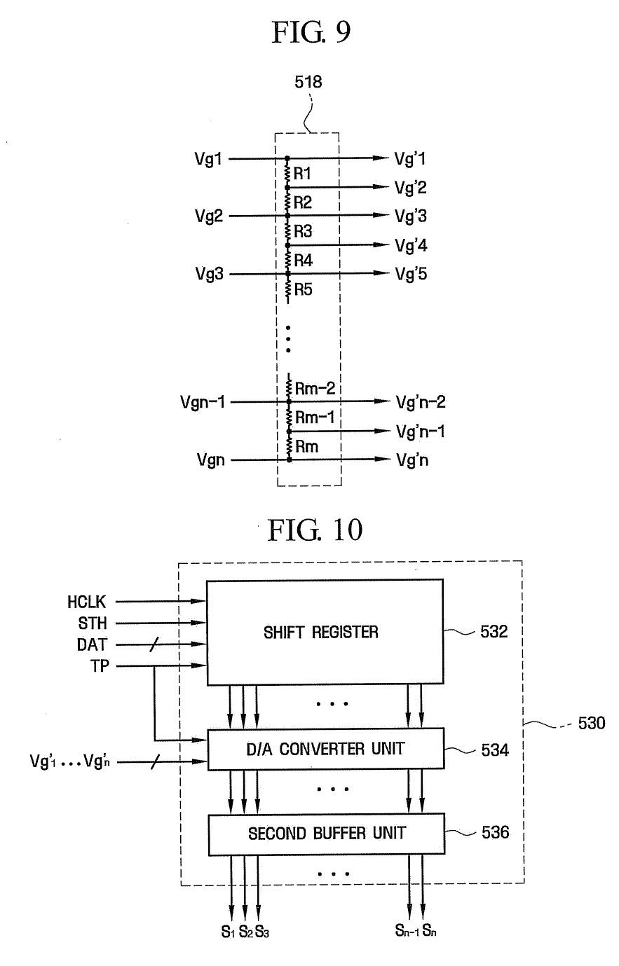

FIG. 7 is an internal block diagram of an exemplary embodiment of the data driving unit 500 according to the present invention. FIG. 8 is an internal block diagram of an exemplary embodiment of the grayscale voltage generation unit 510 of FIG. 7. FIG. 9 is an internal block diagram of an exemplary embodiment of a resistor string unit 518 of FIG. 8.

Referring to FIG. 7, the data driving unit 500 according to the current exemplary embodiment of the present invention includes the grayscale voltage generation unit 510 and a driving unit 530.

Referring to FIG. 8, the grayscale voltage generation unit 510 includes a second memory unit 512, a digital-analog converter unit 514 for the reference grayscale voltage, a first buffer unit 516, and the resistor string unit 518.

The second memory unit 512 includes a plurality of registers (not shown), receives the grayscale generation signal GMA_GEN from the timing control unit 600 through the serial data line SDL, and stores the received grayscale generation signal GMA_GEN.

The digital-analog converter unit 514 for the reference grayscale voltage includes a plurality of digital-analog converters (not shown). The digital-analog converter unit 514 for the reference grayscale voltage receives the grayscale generation signal GMA_GEN having the plurality of resistances and the offset voltage values and outputs a plurality of reference grayscale voltages Vg1, . . . , and Vgn.

The first buffer unit 516 includes a plurality of buffers (not shown) connected to the digital-analog converter unit 514 for the reference grayscale voltage. The individual buffers maintain the reference grayscale voltages Vg1, . . . , and Vgn, respectively, which are output from the digital-analog converter unit 514 for a reference grayscale voltage constant.

The resistor string unit 518 is connected to the first buffer unit 516. As shown in FIG. 9, the resistor string unit 518 distributes the plurality of reference grayscale voltages Vg1, . . . , and Vgn and generates a plurality of grayscale voltages Vg′1, . . . , and Vg′n having different levels. In the resistor string unit 518, the resistor strings are respectively connected between adjacent buffers. Each of the resistor strings has two resistors R1, . . . , and Rm in series. In alternative exemplary embodiments in order to generate more grayscale voltages, the resistor string may connect more resistors in series, e.g., if each resistor string has two resistors, the number of grayscale voltages is doubled, if each resistor string includes three resistors, the number of grayscale voltages is tripled, etc. For this reason the resistor string 518 may also be referred to as a voltage divider.

FIG. 10 is an internal block diagram of an exemplary embodiment of the driving unit shown in FIG. 7.

Referring to FIG. 10, the exemplary embodiment of a driving unit 530 according to the present invention is driven by receiving the plurality of reference grayscale voltages Vg′1, . . . , and Vg′n from the grayscale voltage generation unit 510. The driving unit 530 includes a shift register 532, a digital-analog converter 534, and a second buffer unit 536.

If a horizontal synchronization start signal STH is input, the shift register 532 receives the corrected image signal DAT supplied from the timing control unit 600 and latches the corrected image signal DAT at a rising edge of the horizontal synchronization start signal STH. Thereafter, the shift register 532 continuously stores the corrected image signal DAT while shifting the corrected image signal DAT.

If the data driving unit 500 becomes full with the corrected image signal DAT through the above-described process, when a load signal TP input to the shift register 532 rises, the shift register 532 outputs all of the corrected image signals DAT to the digital-analog converter unit 534.

The digital-analog converter unit 534 receives the corrected image signals DAT from the shift register 532, converts the received corrected image signals DAT into analog data voltages corresponding to the corrected image signals DAT, and outputs the converted analog data voltages to the second buffer unit 536 when the load signal TP input to the digital-analog converter 534 falls.

The second buffer unit 536 selects the polarities of the analog data voltages from the digital-analog converter 534 and applies the analog data voltages S1 to Sn having the selected polarities to the data lines D1 to Dm of the liquid crystal panel 100. In one exemplary embodiment the number of data voltages Sn is equal to the number of data lines Dm.

Although the present invention has been described in connection with the exemplary embodiments of the present invention, it will be apparent to those skilled in the art that various modifications and changes may be made thereto without departing from the scope and spirit of the present invention. Therefore, it should be understood that the above embodiments are not limitative, but illustrative in all aspects. The scope of the present invention is defined by the appended claims rather than by the description preceding them, and all changes and modifications which fall within metes and bounds of the claims, or equivalents of such metes and bounds are therefore intended to be embraced by the claims.

According to the above-described exemplary embodiments of a data driving apparatus, a liquid crystal display including the same, and a method of driving a liquid crystal display of the present invention, the grayscale voltage generation unit which generates the reference grayscale voltages is provided in the data driving unit, thereby reducing the number of wiring lines to be formed on the printed circuit board and reducing the size of the printed circuit board.

Further, it is possible to adjust reference grayscale voltages according to image signals from the outside, thereby representing fine image quality from a black grayscale level to a white grayscale level.

What is claimed is:

1. A data driving apparatus comprising:
an integrated circuit chip;
a grayscale voltage generation unit disposed on the integrated circuit chip which receives grayscale generation signals from the outside and generates a plurality of reference grayscale voltages; and
a driving unit disposed on the integrated circuit chip which receives the reference grayscale voltages, converts image signals from the outside into corresponding analog data voltages, and supplies the converted analog data voltages to data lines of a liquid crystal panel.

2. The data driving apparatus of claim 1, wherein the grayscale voltage generation unit comprises:
a plurality of first memory units which receive and store the grayscale generation signals;
a plurality of digital-analog converters, correspondingly connected to the plurality of first memory units, which convert the grayscale generation signals into a plurality of analog grayscale voltages and output the analog grayscale voltages to a plurality of nodes; and
a plurality of resistor string units, respectively connected between the nodes in series, which distribute the grayscale voltages and output the plurality of reference grayscale voltages.

3. The data driving apparatus of claim 2, wherein the grayscale generation signals comprise a plurality of resistances and offset voltage values to generate the reference grayscale voltages.

4. The data driving apparatus of claim 3, wherein, when a first region indicates a voltage difference between a common voltage and a driving voltage and a second region indicates a voltage difference between the common voltage and a ground voltage and, the offset voltage values comprise:
a first offset voltage value indicating a voltage difference between the driving voltage and a positive maximum grayscale voltage in the first region;
a second offset voltage value indicating a voltage difference between the common voltage and a positive minimum grayscale voltage in the first region;
a third offset voltage value indicating a voltage difference between the common voltage and a negative minimum grayscale voltage in the second region; and
a fourth offset voltage value indicating a voltage difference between the ground voltage and a negative maximum grayscale voltage in the second region.

5. The data driving apparatus of claim 1, wherein the image signals are transmitted using a reduced swing differential signal transmission method.

6. The data driving apparatus of claim 2, wherein the grayscale generation signals are transmitted using an inter integrated circuit transmission method.

7. A liquid crystal display comprising:
a liquid crystal panel comprising a plurality of unit pixels provided substantially at intersections of a plurality of gate lines and a plurality of data lines;
a timing control unit which generates control signals which drive the liquid crystal panel, and receives image signals for every frame, wherein the timing control unit comprises an image signal correction unit which determines to which grayscale level the distribution of the image signal received in an n-th frame corresponds among a plurality of grayscale levels and outputs a corrected image signal according to the result of the determination;
a driving voltage generation unit which receives the control signals and generates a plurality of driving voltages;
a gate driving unit which receives the driving voltages and applies the received driving voltages to the gate lines; and
a data driving device comprising:
an integrated circuit chip;
a grayscale voltage generation unit disposed on the integrated circuit chip which receives grayscale generation signals from the outside and generates a plurality of reference grayscale voltages; and
a driving unit disposed on the integrated circuit chip which receives the reference grayscale voltages, converts the corrected image signals from the timing control unit into corresponding analog data voltages, and supplies the converted analog data voltages to the data lines of the liquid crystal panel.

8. The liquid crystal display of claim 7, wherein the plurality of grayscale levels includes a first grayscale level, a second grayscale level, and a third grayscale level.

9. The liquid crystal display of claim 8, wherein:
the third grayscale level corresponds to the highest grayscale levels;
the second grayscale level corresponds to a set of grayscales lower than the third set of grayscales; and
the first grayscale level corresponds to a set of grayscales lower than the second set of grayscales.

10. The liquid crystal display of claim 7, further comprising:
a first memory unit which stores the grayscale generation signals,
wherein the first memory unit stores at least one of the grayscale generation signals corresponding to the plurality of grayscale levels, an ACC look-up table for correcting colors, and a DCC look-up table for improving a response speed of the liquid crystal display.

11. The liquid crystal display of claim 10, wherein the first memory unit is located outside the data driving device.

12. The liquid crystal display of claim 10, wherein the first memory unit is an electrically erasable programmable read only memory.

13. The liquid crystal display of claim 7, wherein the grayscale generation signals corresponding to at least one level among the plurality of grayscale levels are selected on the basis of the determination of the image signal correction unit.

14. The liquid crystal display of claim 7, wherein one of the ACC look-up table and the DCC look-up table is selected on the basis of the determination of the image signal correction unit to correct the image signals.

15. The liquid crystal display of claim 7, wherein the grayscale generation signals comprise a plurality of resistances and offset voltage values to generate the reference grayscale voltages.

16. The liquid crystal display of claim 15, wherein, when a first region indicates a voltage difference between a common voltage and a driving voltage and a second region indicates a voltage difference between the common voltage, and the offset voltage values comprise:
a first offset voltage value indicating a voltage difference between the driving voltage and a positive maximum grayscale voltage in the first period;
a second offset voltage value indicating a voltage difference between the common voltage and a positive minimum grayscale voltage in the first region;
a third offset voltage value indicating a voltage difference between the common voltage and a negative minimum grayscale voltage in the second region; and
a fourth offset voltage value indicating a voltage difference between the ground voltage and a negative maximum grayscale voltage in the second region.

17. The liquid crystal display of claim 7, wherein the grayscale voltage generation unit comprises:
a plurality of memory units receiving and storing the grayscale generation signals;
a plurality of digital-analog converters, correspondingly connected to the plurality of memory units, respectively, which convert the grayscale generation signals into a plurality of analog grayscale voltages and output the analog grayscale voltages to a plurality of nodes; and
a plurality of resistor string units, respectively connected between the nodes in series, which distribute the grayscale voltages and output the plurality of reference grayscale voltages.

18. A method of driving a liquid crystal display; the method comprising:
providing a liquid crystal display which includes switching elements correspondingly connected to a plurality of gate lines and data lines and a plurality of pixels arranged at intersections of the plurality of gate lines and data lines in a matrix shape;
applying driving voltages to the gate lines;
receiving image signals for every frame
determining which grayscale level the distribution of the image signals received in an n-th frame corresponds to among a plurality of grayscale levels;
supplying corrected image signals according to the result of the determination to a data driving unit;
transmitting grayscale generation signals from a timing control unit to the data driving unit;
generating a plurality of reference grayscale voltages in the data driving unit;
converting the corrected image signals into corresponding analog data voltages; and
supplying the converted analog data voltages to the data lines.

19. The method of claim 18, further comprising:
selecting the grayscale generation signals corresponding to at least one level among the plurality of grayscale levels on the basis of the result of the determination.

20. The method of claim 18, further comprising:
selecting one of the ACC look-up table and the DCC look-up table on the basis of the determination result to correct the image signals.

21. The method of claim 18, wherein the plurality of grayscale levels includes a first grayscale level, a second grayscale level, and a third grayscale level.

22. The method of claim 21, wherein:
the third grayscale level corresponds to the highest grayscale levels
the second grayscale level corresponds to a set of grayscales lower than the third set of grayscales; and
the first grayscale level corresponds to a set of grayscales lower than the second set of grayscales.

23. The method of claim 18, further wherein the converting the corrected image signals into corresponding analog data voltages and supplying the converted analog data voltages to the data lines further comprises:
selecting the analog data voltages before supplying the selected analog voltages to the data lines.

24. The method of claim 23, wherein the grayscale generation signals comprise a plurality of resistances and offset voltage values to generate the reference grayscale voltages.

25. The method of claim 24, wherein, when a first region indicates a voltage difference between a common voltage and a driving voltage and a second region indicates a voltage difference between the common voltage and a ground voltage, and the offset voltage values include:
a first offset voltage value indicating a voltage difference between the driving voltage and a positive maximum grayscale voltage in the first region;
a second offset voltage value indicating a voltage difference between the common voltage and a positive minimum grayscale voltage in the first region;
a third offset voltage value indicating a voltage difference between the common voltage and a negative minimum grayscale voltage in the second region; and
a fourth offset voltage value indicating a voltage difference between the ground voltage and a negative maximum grayscale voltage in the second region.
